(19) United States
(12) Patent Application Publication
(10) Pub. No.: US 2019/0026969 A1
(43) Pub. Date: Jan. 24, 2019

(54) SHEET MEDIUM FLATTENING APPARATUS AND FINANCIAL SELF-SERVICE DEVICE

(71) Applicant: GRG Banking Equipment Co., Ltd., Guangzhou, Guangdong (CN)

(72) Inventor: Zhongwu Lai, Guangzhou, Guangdong (CN)

(73) Assignee: GRG Banking Equipment Co., Ltd., Guangzhou, Guangdong (CN)

(21) Appl. No.: 16/071,798

(22) PCT Filed: Jun. 5, 2017
(86) PCT No.: PCT/CN2017/087125

§ 371 Date: Jul. 20, 2018

(30) Foreign Application Priority Data
Jun. 30, 2016 (CN) 201610513396.9

(51) Int. Cl. G07D 11/00

(52) U.S. Cl. CPC G07D 11/003; B65H 29/52; G07D 11/0018

(57) ABSTRACT

A sheet medium flattening apparatus includes a support frame, wherein a first passage plate and a second passage plate are arranged on the support frame, and a gap between the first passage plate and the second passage plate is a conveying passage; a conveying wheel set arranged in the conveying passage and configured to drive a sheet medium to be conveyed inside the conveying passage; the first passage plate is provided with a through hole, and the second passage plate is provided with a groove at a position corresponding to the through hole; the sheet medium flattening device further includes a flattening block, and the flattening block is configured to be controlled by a driving mechanism to extend into and withdraw from the conveying passage.

The present application claims the benefit of priority to Chinese Patent Application No. 201610513396.9 titled “SHEET MEDIUM FLATTENING DEVICE AND FINANCIAL SELF-SERVICE EQUIPMENT”, filed with the Chinese State Intellectual Property Office on Jun. 30, 2016, the entire disclosure thereof is incorporated herein by reference.

### FIELD

The present application relates to the technical field of mechanical industry, more specifically relates to a sheet medium flattening device, and further relates to a financial self-service equipment employing the sheet medium flattening device.

### BACKGROUND

A sheet medium is usually required to be curled during transport and storage processes, and descriptions are made as follows by taking banknotes in a financial self-service equipment as an example.

Banknotes are stored in a reel-type banknote box in the financial self-service equipment, and the banknotes will be bent into arc-shaped structures after being stored for a long time, which causes the banknotes to be easily jammed when being conveyed inside the financial self-service equipment, thereby resulting in a halt of the financial self-service equipment.

Obviously, a technical problem to be addressed urgently by those skilled in the art is to restore the sheet medium bent into an arc-shaped structure to the flat and straight state, to facilitate taking the sheet medium.

### SUMMARY

In view of this, a sheet medium flattening device is provided according to the present application, a flattening block thereof can push a sheet medium into a groove of a second passage plate to restore an arc-shaped sheet medium to a flat and straight state, such that it is convenient for users to take the sheet medium. A financial self-service equipment employing the sheet medium flattening device is further provided according to the present application, which can flatten arc-shaped banknotes and prevent the banknote jamming when the banknotes are conveyed in the financial self-service equipment, to improve the reliability of the financial self-service equipment.

In order to achieve above objects, the following technical solutions are provided according to the present application.

A sheet medium flattening device includes:

a support frame, wherein a first passage plate and a second passage plate are arranged on the support frame, and a gap between the first passage plate and the second passage plate is a conveying passage;

a conveying wheel set arranged in the conveying passage and configured to drive a sheet medium to be conveyed inside the conveying passage;

wherein, the first passage plate is provided with a through hole, and the second passage plate is provided with a groove at a position corresponding to the through hole; the sheet medium flattening device further includes a flattening block, and the flattening block is configured to be controlled by a driving mechanism to extend into and withdraw from the conveying passage; and

wherein, in a case that the driving mechanism controls the flattening block to extend into the conveying passage, the flattening block is configured to push the sheet medium into the groove; and

in a case that the driving mechanism controls the flattening block to withdraw from the conveying passage, a next sheet medium is allowed to be conveyed along the conveying passage to a position corresponding to the groove.

Preferably, in the sheet medium flattening device, the conveying wheel set includes a first conveying wheel set, the first conveying wheel set includes a driving wheel which is arranged on the first passage plate or the support frame and is rotatable around its own axis, and a driven wheel which is arranged on the second passage plate or the support frame and is rotatable around its own axis; the axis of the driving wheel is parallel with the axis of the driven wheel, the driving wheel and the driven wheel extend into the conveying passage, and wheel faces of the driving wheel and the driven wheel are abutting against each other; the driving wheel is driven by a first motor, and in a rotating process, the driving wheel is configured to drive the driven wheel to rotate reversely to convey the sheet medium clamped between the driving wheel and the driven wheel along the conveying passage.

Preferably, in the sheet medium flattening device, the flattening block is located at a position upstream of the first conveying wheel set in a conveying direction of the sheet medium and close to the first conveying wheel set.

Preferably, the sheet medium flattening device further includes a control unit, and a sensor located downstream of the first conveying wheel set in the conveying direction of the sheet medium, the sensor is arranged on the first passage plate and/or the second passage plate; the sensor is configured to detect whether the sheet medium is located in the conveying passage at a position corresponding to the sensor; and

in a case that a detection result of the sensor is YES, the control unit is configured to control the driving mechanism to move, to allow the flattening block to extend into the conveying passage to push the sheet medium tightly into the groove; and

in a case that the detection result of the sensor is NO, the control unit is configured to control the driving mechanism to move, to allow the flattening block to withdraw from the conveying passage.

Preferably, in the sheet medium flattening device, a sliding slot is provided in the support frame at a position configured to assemble the flattening block, the driving mechanism includes a second motor, an output shaft of the second motor is provided with a driving gear, the flattening block is provided with toothed grooves configured to mesh with the driving gear; and the second motor is configured to allow the flattening block to slide along the sliding slot through the driving gear, to extend into or withdraw from the conveying passage.

Preferably, in the sheet medium flattening device, a value range of a distance d1 between an effective detecting point of the sensor and a first plane is: 0 mm<d1<15 mm; and the first plane is a plane where the axis of the driving wheel and the axis of the driven wheel lie.

Preferably, in the sheet medium flattening device, an end surface of a top end, configured to cooperate with the groove, of the flattening block is an arc surface, and a range of a curvature radius R of the arc surface is 0 mm to 6 mm.

Preferably, in the sheet medium flattening device, a value range of a distance d2 between a circle center of the arc surface and the first plane is: 5 mm<d2<15 mm; and the first plane is the plane where the axis of the driving wheel and the axis of the driven wheel lie.

Preferably, in the sheet medium flattening device, the conveying wheel set further includes a second conveying wheel set, the second conveying wheel set has the same structure with the first conveying wheel set, and the second conveying wheel set is located upstream of the first conveying wheel set in the conveying direction of the sheet medium; and a distance between the second conveying wheel set and the first conveying wheel set is smaller than a length of the sheet medium in the conveying direction.

A financial self-service equipment has an outlet/inlet, and includes a sheet medium storage device and a sheet medium conveying passage connecting the outlet/inlet with the sheet medium storage device; the sheet medium conveying passage is provided with the sheet medium flattening device according to any one of the above solutions.

A sheet medium flattening device is provided according to the present application, which includes a support frame and a conveying wheel set, wherein a first passage plate and a second passage plate are arranged on the support frame, a gap between the first passage plate and the second passage plate is a conveying passage; the conveying wheel set is arranged in the conveying passage, and is configured to drive the sheet medium to be conveyed inside the conveying passage. The first passage plate is provided with a through hole, and the second passage plate is provided with a groove at a position corresponding to the through hole. The sheet medium flattening device further includes a flattening block, which can extend into and withdraw from the conveying passage under the control of a driving mechanism, when the driving mechanism controls the flattening block to extend into the conveying passage, the flattening block pushes the sheet medium into the groove; and when the driving mechanism controls the flattening block to withdraw from the conveying passage, a next sheet medium can be conveyed along the conveying passage to a position corresponding to the groove.

Obviously, when the sheet medium flattening device is employed, the sheet medium is put in the conveying passage, and is conveyed in the conveying passage in a state that an outer side of the sheet medium faces the first passage plate and an inner side of the sheet medium faces the second passage plate, so that the sheet medium can be flattened by the cooperation of the flattening block and the groove, which can prevent the sheet medium from being shaped into an arc-shaped structure, thus avoids affecting the subsequent employment of the sheet medium.

A financial self-service equipment is further provided according to the present application, and employs the sheet medium flattening device, thus can flatten arc-shaped banknotes and prevent the banknotes from being jammed when being conveyed in the financial self-service equipment, thereby improving the reliability of the financial self-service equipment.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a perspective structural schematic view of a sheet medium flattening device according to an embodiment of the present application;

FIG. 2 is a perspective structural schematic view of the sheet medium flattening device in FIG. 1 viewed from another angle;

FIG. 3 is a sectional structural schematic view of the sheet medium flattening device in FIG. 1;

FIG. 4 is an enlarged view of portion A in FIG. 3;

FIG. 5 is a structural schematic view showing a state that a sheet medium just entered a conveying passage of the sheet medium flattening device in FIG. 1 according to the embodiment of the present application;

FIG. 6 is a structural schematic view showing a state that the sheet medium entered a first conveying wheel set of the sheet medium flattening device in FIG. 1 according to the embodiment of the present application;

FIG. 7 is a structural schematic view showing a state that the sheet medium arrives at a position, corresponding to a sensor, in the conveying passage of the sheet medium flattening device in FIG. 1 according to the embodiment of the present application;

FIG. 8 is a structural schematic view showing a state that the sheet medium arrives at a third conveying wheel set of the sheet medium flattening device in FIG. 1 according to the embodiment of the present application;

FIG. 9 is a structural schematic view showing a state that the sheet medium is outputted from the conveying passage of the sheet medium flattening device in FIG. 1 according to the embodiment of the present application;

FIG. 10 is a schematic view showing an assembly of a second motor, a driving gear and a flattening block according to an embodiment of the present application;

FIG. 11 is a schematic view showing an assembly of a driving wheel of the first conveying wheel set and a first rotating shaft;

FIG. 12 is a structural schematic view showing the sheet medium flattening device according to the embodiment of the present application, wherein a driving mechanism of the sheet medium flattening device includes an unidirectional electromagnet;

FIG. 13 is a structural schematic view showing the sheet medium flattening device according to the embodiment of the present application, wherein the driving mechanism of the sheet medium flattening device includes a rotary electromagnet;

FIG. 14 is a sectional structural schematic view of the sheet medium flattening device in FIG. 13;

FIG. 15 is a structural schematic view showing a state that the flattening block is located outside the conveying passage in the sheet medium flattening device according to the embodiment of the present application, wherein the driving mechanism of the sheet medium flattening device includes a cam;

FIG. 16 is a structural schematic view showing a state that in the sheet medium flattening device in FIG. 15, the flattening block extends into the conveying passage and abuts against a groove.

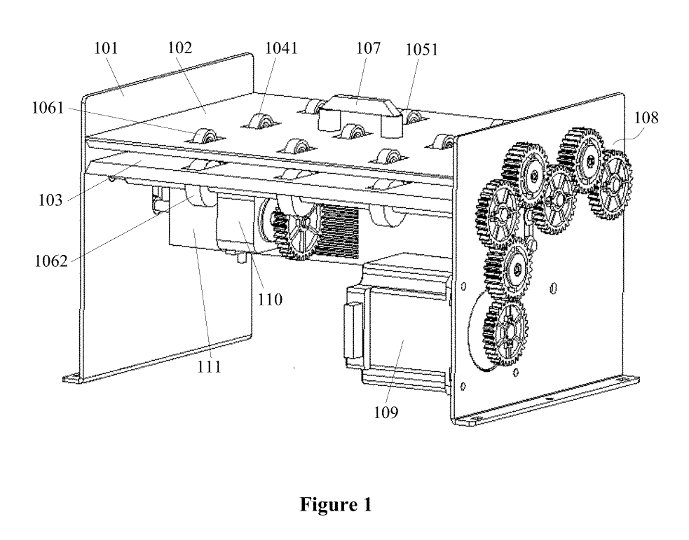

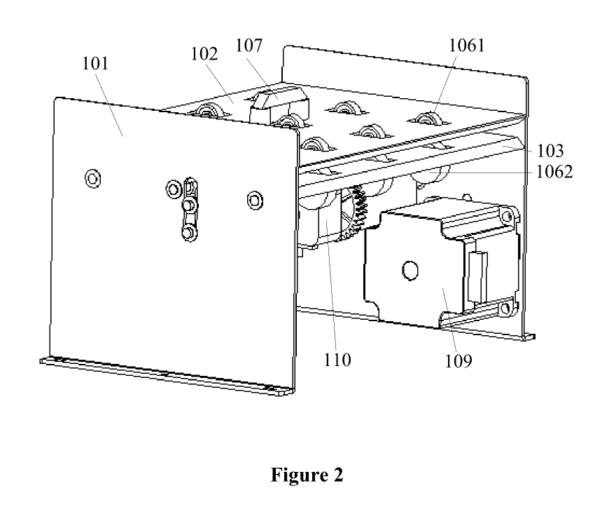

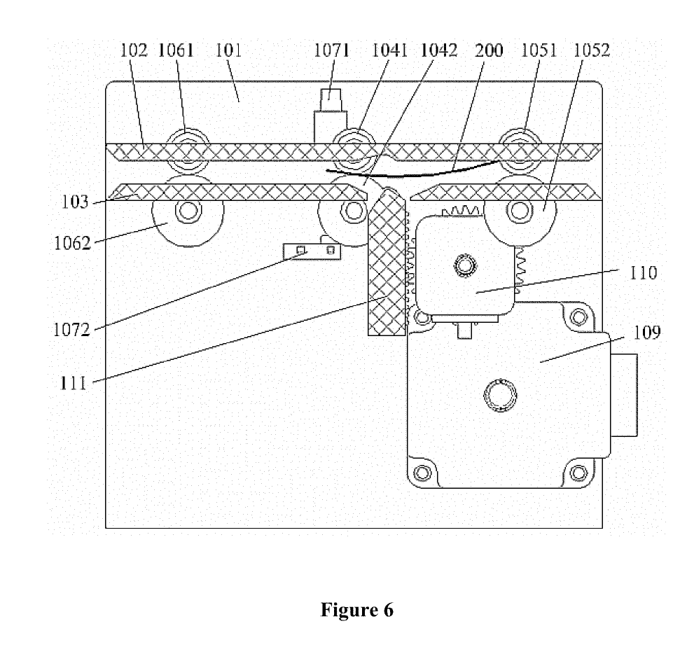

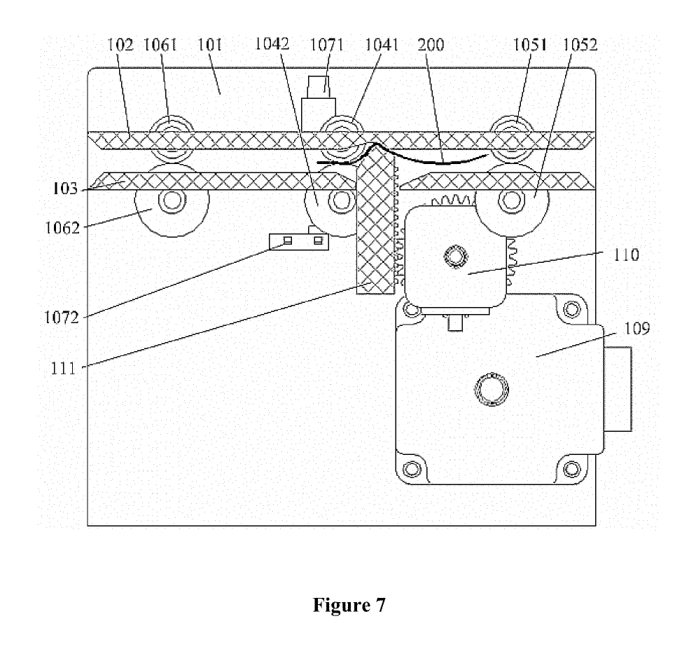

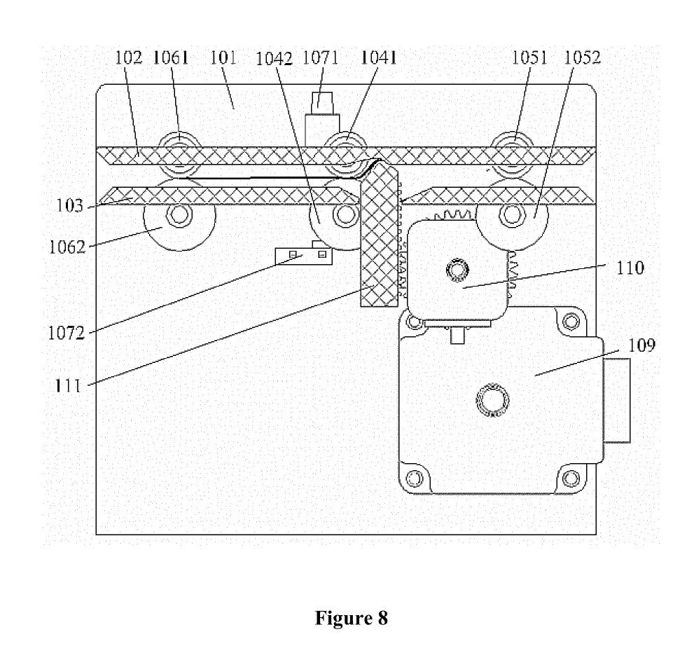

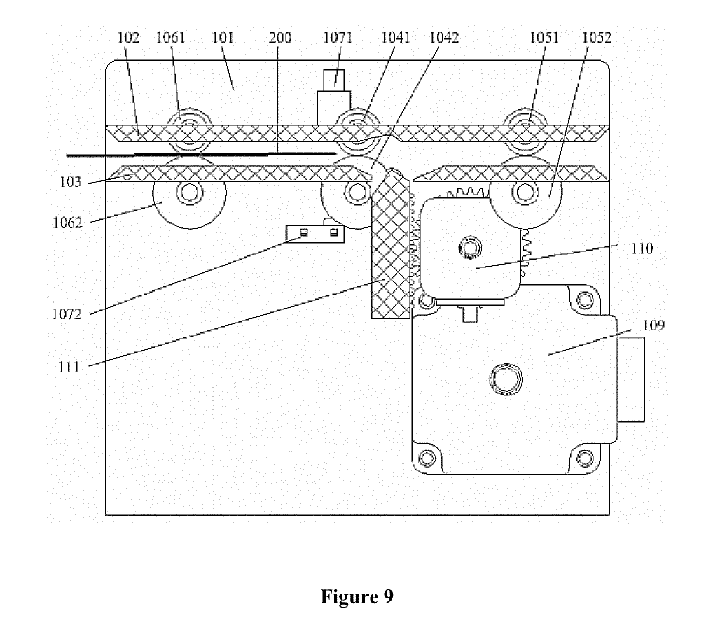

Reference Numerals in FIGS. 1 to 16:

| | | | |
|---|---|---|---|
| 101 | support frame, | 102 | second passage |
| | | | plate, |
| 103 | second passage | 104 | first conveying |
| | plate, | | wheel set, |
| 105 | second conveying | 106 | third conveying |
| | wheel set, | | wheel set, |
| 1041, 1051, | driven wheel, | 1042, 1052, | driving wheel, |
| 1061 | | 1062 | |
| 1043 | first rotating shaft, | 107 | sensor, |
| 1071 | emitter, | 1072 | receiver, |
| 108 | gear train, | 109 | first motor, |
| 110 | second motor, | 1101 | driving gear, |
| 111 | flattening block, | 112 | unidirectional |
| | | | electromagnet, |
| 113 | rotary electromagnet, | 114 | cam, |
| 200 | sheet medium. | | |

### DETAIL DESCRIPTION

A sheet medium flattening device is provided according to an embodiment of the present application, a flattening block thereof can push a sheet medium into a groove of a second passage plate, to restore an arc-shaped sheet medium to the flat and straight state, such that it is convenient for users to take the sheet medium. A financial self-service equipment employing the sheet medium flattening device is further provided according to the present application, which can flatten arc-shaped banknotes and prevent the banknote jamming when the banknotes are conveyed in the financial self-service equipment, to improve the reliability of the financial self-service equipment.

The technical solution according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work fall within the scope of the present application.

Referring to FIGS. 1 to 16, a sheet medium flattening device is provided according to the embodiment of the present application, which includes a support frame 101 and a conveying wheel set. A first passage plate 103 and a second passage plate 102 are provided on the support frame 101, and a gap between the first passage plate 103 and the second passage plate 102 is a conveying passage. The conveying wheel set is arranged in the conveying passage, and is configured to drive the sheet medium 200 to be conveyed in the conveying passage. The first passage plate 103 is provided with a through hole, and the second passage plate 102 is provided with a groove at a position corresponding to the through hole. The sheet medium flattening device further includes a flattening block 111, and the flattening block can be controlled by a driving mechanism to extend into and withdraw from the conveying passage. When the driving mechanism controls the flattening block 111 to extend into the conveying passage, the flattening block 111 pushes the sheet medium 200 into the groove; and when the driving mechanism controls the flattening block 111 to withdraw from the conveying passage, a next sheet medium 200 can be conveyed along the conveying passage to a position corresponding to the groove.

Obviously, when the sheet medium flattening device is employed, the sheet medium 200 is put in the conveying passage, and is conveyed in the conveying passage in a state that an outer side of the sheet medium 200 faces the first passage plate 103 and an inner side of the sheet medium 200 faces the second passage plate 102, so that the sheet medium 200 can be flattened by the cooperation of the flattening block 111 and the groove, which can prevent the sheet medium 200 from being shaped into an arc-shaped structure, thus avoids affecting the subsequent employment of the sheet medium 200.

The conveying wheel set includes a first conveying wheel set 104. The first conveying wheel set 104 includes a driving wheel 1042 which is arranged on the first passage plate 103 or the support frame 101 and is rotatable around its own axis, and a driven wheel 1041 which is arranged on the second passage plate 102 or the support frame 101 and is rotatable around its own axis. The axis of the driving wheel 1042 is parallel with the axis of the driven wheel 1041, an outer edge of the driving wheel 1042 and an outer edge of the driven wheel 1041 extend through the first passage plate 103 and the second passage plate 102, respectively, into the conveying passage, and wheel faces of the driving wheel 1042 and the driven wheel 1041 can abut against each other in the conveying passage. The driving wheel 1042 is driven by a first motor 109, and in a rotating process, the driving wheel 1042 can drive the driven wheel 1041 to rotate in a direction opposite to a rotating direction of the driving wheel 1042, to convey the sheet medium 200 clamped between the driving wheel 1042 and the driven wheel 1041 along the conveying passage.

Specifically, in the sheet medium flattening device, the first conveying wheel set 104 conveys the sheet medium 200 in a first direction in the conveying passage. The first direction is the direction perpendicular to a first plane and facing an outlet end of the conveying passage, and the first plane is the plane where the axis of the driving wheel 1042 and the axis of the driven wheel 1041 of the first conveying wheel set 104 lie.

In the sheet medium flattening device, the flattening block 111 is located at an upstream side of the first conveying wheel set 104 in a conveying direction of the sheet medium, and the flattening block 111 is close to the first conveying wheel set 104. During usage, an end of the sheet medium 200 first passes through a position corresponding to the flattening block 111 in the conveying passage, and then arrives a position between the driving wheel 1042 and the driven wheel 1041 of the first conveying wheel set 104, then the flattening block 111 extends into the conveying passage to push the sheet medium 200 into the groove of the second passage plate 102. Obviously, arranging the flattening block 111 at the upstream side of the first conveying wheel set 104 can ensure that the sheet medium 200 gradually passes through a clearance between the flattening block 111 and the groove under the action of the first conveying wheel set 104, to be conveyed along the conveying passage.

Movements of the flattening block 111 extending into and withdrawing from the conveying passage are controlled by a control unit, and accordingly, the sheet medium flattening device further includes a sensor 107 located in front of the first conveying wheel set 104. The sensor 107 is arranged on the first passage plate 103 and/or the second passage plate 102, and is configured to detect whether or not the sheet medium 200 is located at a position corresponding to the sensor 107 inside the conveying passage.

In a case that a detection result of the sensor 107 is YES, the control unit controls the driving mechanism in cooperation with the flattening block 111 to move, to allow the flattening block 111 to extend into the conveying passage and abut the sheet medium 200 tightly into the groove.

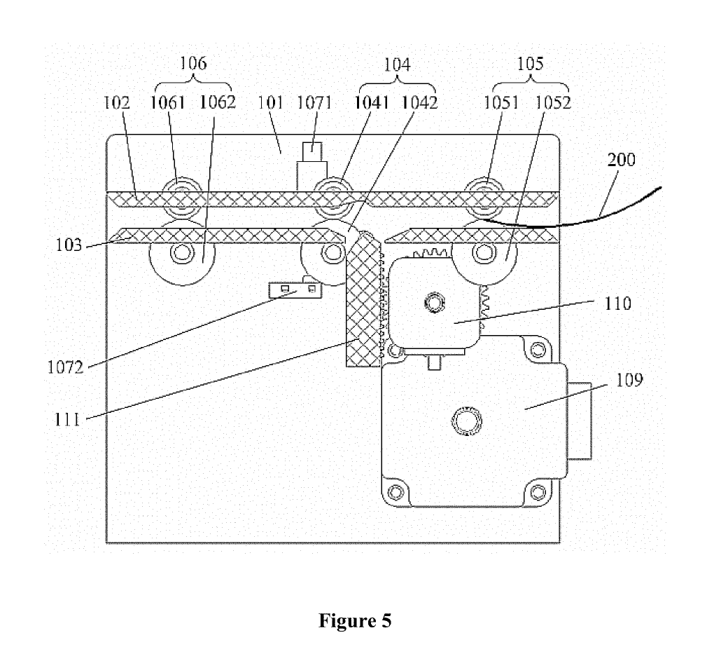

In a case that the detection result of the sensor 107 is NO, the control unit controls the driving mechanism to move, to allow the flattening block 111 to withdraw from the conveying passage, so that the next sheet medium 200 can be conveyed to the position corresponding to the flattening block 111 in the conveying passage. The whole process is shown in FIGS. 5 to 9, in an initial state, the flattening block 111 is located outside the conveying passage, and an end portion of the flattening block 111 is lower than a surface, facing the second passage plate 102, of the first passage plate 103; during usage, the sheet medium 200 first arrives at the first conveying wheel set 104 through the conveying passage, then is conveyed by the first conveying wheel set 104 to arrive at the position corresponding to the sensor 107, the sensor 107 transmits the detection result that the sheet medium 200 is located at the position corresponding to the sensor 107 to the control unit, and the control unit controls, by the driving mechanism, the flattening block 111 to extend into the conveying passage to push the sheet medium 200 tightly into a groove bottom of the groove, finally the sheet medium 200 sequentially passes through the flattening block 111, the first conveying wheel set 104 and the sensor 107. Correspondingly, the sensor 107 transmits the detection result that the sheet medium 200 has not arrived at the position corresponding to the sensor 107 in the conveying passage to the control unit, and the control unit controls, by the driving mechanism, the flattening block 111 to withdraw from the conveying passage through the through hole in the first passage plate 103 until the end portion of the flattening block 111 is lower than the surface, facing the second passage plate 102, of the first passage plate 103, so as to prevent the flattening block 111 from blocking the next sheet medium 200 from reaching the first conveying wheel set 104 through the conveying passage. Obviously, by continuously repeating the above process, multiple arc-shaped sheet mediums 200 can be sequentially flattened.

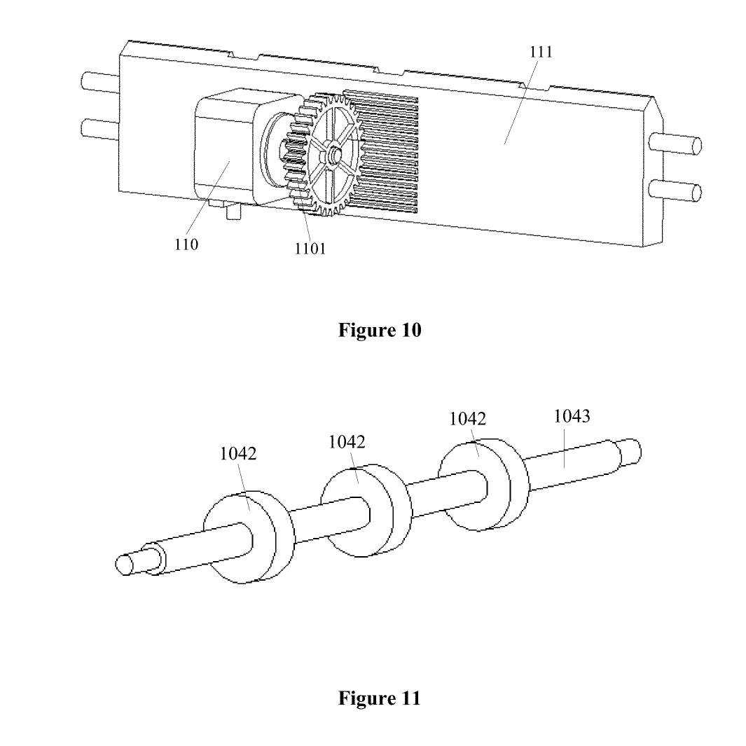

As shown in FIG. 10, a position corresponding to the flattening block 111 at the support frame 101 is provided with a sliding slot, and the flattening block 111 is arranged in the sliding slot and can slide along the sliding slot. The driving mechanism includes a second motor 110, an output shaft of the second motor 110 is provided with a driving gear 1101, the flattening block 111 is provided with toothed grooves configured to mesh with the driving gear 1101. During usage, the second motor 110 drives, through the driving gear 1101, the flattening block 111 to slide along the sliding slot, so that the flattening block 111 can extend into or withdraw from the conveying passage through the through hole in the first passage plate 103.

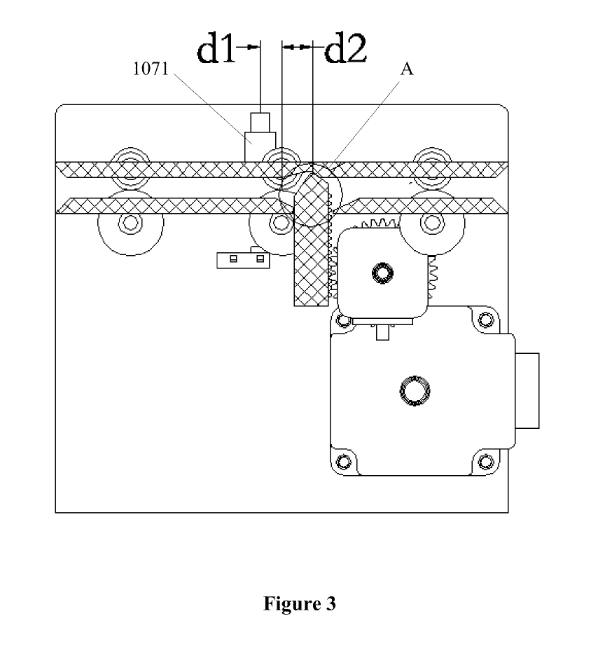

Specifically, in the sheet medium flattening device, the sensor 107 includes a receiver 1072 and an emitter 1071 fixed on the first passage plate 103 and the second passage plate 102 respectively. The emitter 1071 emits a light beam, the receiver 1072 receives the light beam emitted by the emitter 1071, and an effective detecting point of the sensor 107 refers to a position where the sheet medium blocks the receiver 1072 from receiving the light beam. As shown in FIG. 3, a distance between the effective detecting point and the first plane is d1, and a value range of d1 is set as 0 mm<d1<15 mm, wherein the first plane is, as described hereinbefore, the plane where the axis of the driving wheel 1042 and the axis of the driven wheel 1041 lie. In this embodiment, d1 has a small value, thus can shorten a length of a portion of the sheet medium 200 that is not abutted tightly and flattened by the flattening block 111, to improve a flattening effect of the sheet medium 200.

Preferably, in the sheet medium flattening device, an end surface of a top end, configured to cooperate with the groove, of the flattening block 111 is an arc surface, and a curvature radius R of the arc surface ranges from 0 mm to 6 mm. In this solution, the end surface has a small curvature, thus can prevent the sheet medium 200 from forming a reversely bent arc-shaped structure after being pressed by the cooperation of the flattening block 111 and the groove, so as to ensure a good flattening effect of the sheet medium 200.

Further, a value range of a distance d2 between a circle center of the arc surface and the first plane is: 5 mm<d2<15 mm; and the first plane is still the plane where the axis of the driving wheel and the axis of the driven wheel of the first conveying wheel set 104 lie. In this solution, d2 has a small value, so that the flattening block 111 is close to the first conveying wheel set 104, which can further shorten a length of a portion, which is not abutted tightly and flattened by the top end of the flattening block 111, of the sheet medium 200, and enlarge a flattened area of the sheet medium 200, thereby improving the flattening effect.

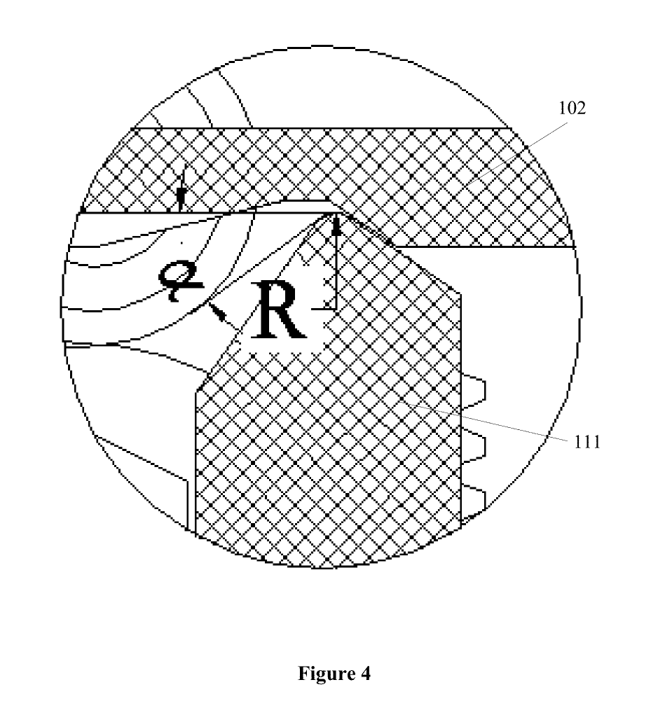

When the flattening block 111 extends into the conveying passage and abuts against the groove bottom of the groove in the second passage plate 102, a range of an included angle α between a tangent line, tangent to both the arc surface of the end portion of the flattening block 111 and the wheel face of the driven wheel 1041 in the first conveying wheel set 104, and the first direction is 0<α<90°, as shown in FIG. 4. A value of the included angle α can be set according to a curving degree of the sheet medium 200, and the greater the curving degree of the sheet medium 200 is, the greater the value of the included angle α is to be set.

In the sheet medium flattening device according to the above embodiment, there are multiple first conveying wheel sets 104, the driving wheels 1041 of the first conveying wheel sets 104 are respectively arranged on a first rotating shaft 1043, as shown in FIG. 11. The first rotating shaft 1043 is arranged on the support frame 101 and is rotatable around its own axis. The number of the first conveying wheel sets 104 may be specifically set according to a size of the sheet medium 200 and sizes of the driving wheel 1042 and the driven wheel 1041 in the first conveying wheel set 104, which is not specifically limited in this embodiment.

Preferably, the conveying wheel set in the sheet medium flattening device further includes a second conveying wheel set 105, the second conveying wheel set 105 has the same structure with the first conveying wheel set 104, a driving wheel 1042 in the second conveying wheel set 105 is arranged on the first passage plate 103 or the support frame 101 and is rotatable around its own axis, and the driven wheel 1051 in the second conveying wheel set 105 is arranged on the second passage plate 102 or the support frame 101 and is rotatable around its own axis. The driving wheel 1052 in the second conveying wheel set 105 extends into the conveying passage through the first passage plate 103, the driven wheel 1051 in the second conveying wheel set 105 extends into the conveying passage through the second passage plate 102. The axis of each wheel in the second conveying wheel set 105 is parallel with the axis of the driving wheel 1042 of the first conveying wheel set 104, and the second conveying wheel set 105 conveys the sheet medium 200 in the same manner as the first conveying wheel set 104, which will not be described herein.

The second conveying wheel set 105 is located at an upstream side of the first conveying wheel set 104 in the conveying direction of the sheet medium. In order to ensure that the sheet medium 200 can be conveyed in the conveying passage, a distance between the first conveying wheel set 104 and the second conveying wheel set 105 is smaller than a length of the sheet medium in the first direction. A distance between the first conveying wheel set 104 and the second conveying wheel set 105 is a distance between a point A and a point B, the point A is the point where the driving wheel 1042 abuts against the wheel face of the driven wheel 1041, and the point B is the point where the driving wheel 1052 abuts against the wheel face of the driven wheel 1051.

There may be multiple second conveying wheel sets 105, the driving wheels 1052 of the second conveying wheel sets 105 are fixed on a second rotating shaft, and the second rotating shaft is arranged on the support frame and is rotatable around its own axis. The first motor 109 drives, through a gear train 108, the first rotating shaft 1043 and the second rotating shaft to simultaneously rotate at a same angular speed in a same direction, to ensure that each of the conveying wheel sets conveys the sheet medium 200 at the same speed, so as to prevent the sheet medium 200 from being damaged when it is pulled by different conveying wheel sets or from being accumulated to form folds when it is not tightened. In each of the above conveying wheel sets, outer diameters of the driving wheels are the same, and outer diameters of the driven wheels are the same.

Of course, the sheet medium flattening device may be further provided with a third conveying wheel set 106, the third conveying wheel set 106 is required to be arranged at a downstream side of the first conveying wheel set 104 in the conveying direction of the sheet medium, and the third conveying wheel set 106 has the same structure and arranging manner as the second conveying wheel set 105, which is not specifically set in this embodiment. However, it should be ensured that the first motor 109 can drive the rotating shafts, on which the driving wheels are fixed, of all the conveying wheel sets to simultaneously rotate at the same angular speed in the same direction through the gear train 108, and it should be ensured that a distance between adjacent conveying wheel sets is smaller than the length of the sheet medium in the first direction. Specifically, planes, where the axes of the driving wheel and the driven wheel of the conveying wheel sets lie, are respectively parallel with each other.

The driving mechanism configured to drive the flattening block 111 to extend into and withdraw from the conveying passage may be further embodied as the following structures.

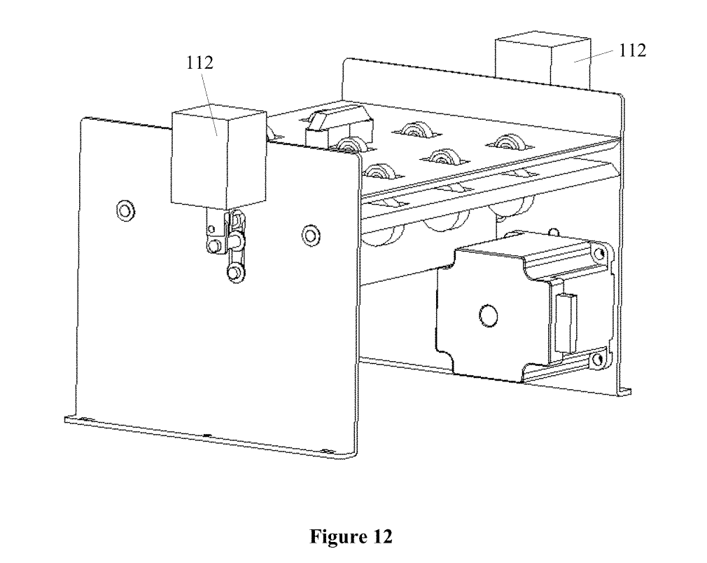

1. The driving mechanism includes an unidirectional electromagnet 112, as shown in FIG. 12, the unidirectional electromagnet 112 is controlled by the control unit, and according to a control signal sent by the control unit, the unidirectional electromagnet 112 drives the flattening block 111 to extend into the conveying passage until abuts against the groove bottom of the groove, or drives the flattening block 111 to withdraw from the conveying passage until the flattening block 111 is lower than the surface, facing the second passage plate 102, of the first passage plate 103.

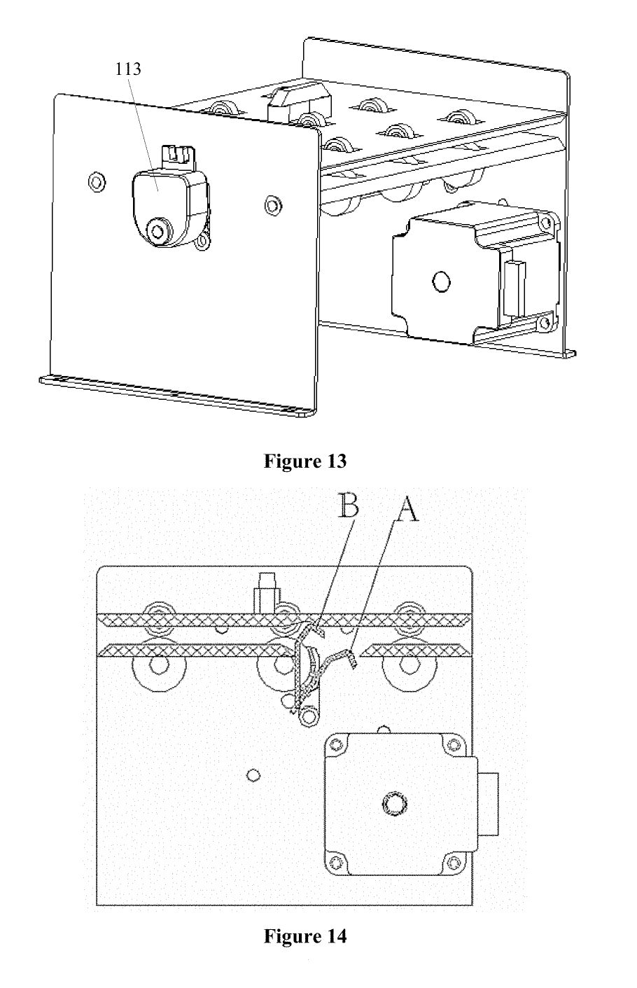

2. The driving mechanism includes a rotary electromagnet 113, as shown in FIGS. 13 to 14, the rotary electromagnet 113 is controlled by the control unit, and according to the control signal sent by the control unit, the rotary electromagnet 113 drives the flattening block 111 to rotate and extend into the conveying passage until abuts against the groove bottom of the groove (that is, arriving at the position B in FIG. 14), or drives the flattening block 111 to rotate and withdraw from the conveying passage until the flattening block 111 is lower than the surface, facing the second passage plate 102, of the first passage plate 103 (that is, arriving at the position A in FIG. 14).

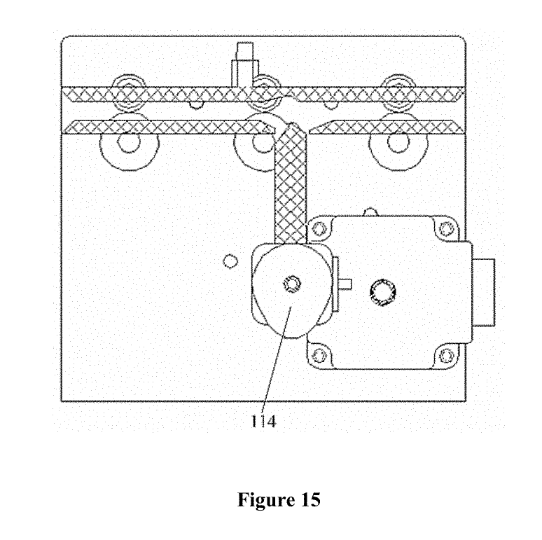

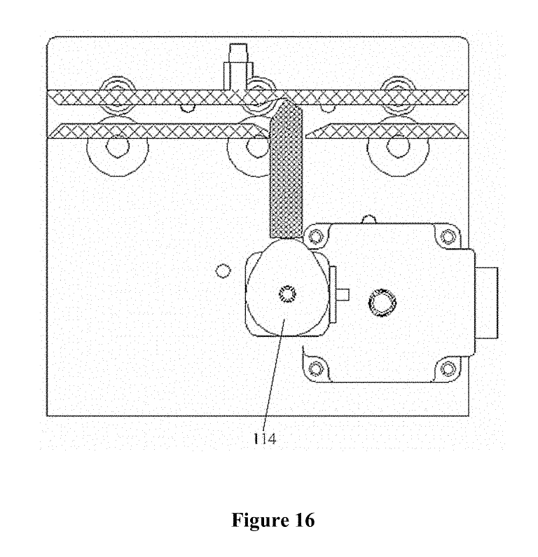

3. The driving mechanism includes a motor and a cam 114, the cam 114 abuts against the flattening block 111, and according to the control signal sent by the control unit, the motor drives the cam 114 to rotate until the cam 114 pushes the flattening block 111 to abut against the groove of the second passage plate 102, as shown in FIG. 16; or the motor drives the cam 114 to rotate until the flattening block 111 withdraws from the conveying passage under an effect of its own gravity or other elastic members and is lower than the surface, facing the second passage plate 102, of the first passage plate 103, as shown in FIG. 15.

This embodiment does not limit the specific structure of the driving mechanism.

Specifically, in the sheet medium flattening device, the first passage plate 103 and the second passage plate 102 are arranged in parallel with each other, and the first passage plate 103 is parallel to both the first direction and an axial direction of the driving wheel 1042. The support frame 101 includes two vertical plates, the above two passage plates are arranged between the two vertical plates and are both fixedly connected to the two vertical plates, wherein the first passage plate 103 and the second passage plate 102 are arranged in a horizontal direction, and the first passage plate 103 is located at a lower side and the second passage plate 102 is located at an upper side. The gear train 108 includes multiple gears sequentially meshed with each other, and all gears of the gear train 108 are arranged on a same vertical plate and are each rotatable around its own axis.

A financial self-service equipment is further provided according to an embodiment of the present application, which has an outlet/inlet, and includes a sheet medium storage device and a sheet medium conveying passage connecting the outlet/inlet with the sheet medium storage device. The sheet medium conveying passage is provided with the sheet medium flattening device according to the above technical solutions. The conveying passage of the sheet medium flattening device is in communication with the sheet medium conveying passage.

The financial self-service equipment according to the embodiment of the present application employs the sheet medium flattening device provided according to the above embodiments, thus can flatten arc-shaped banknotes and prevent the banknotes from being jammed when being conveyed in the financial self-service equipment, thereby improving the reliability of the financial self-service equipment. Of course, the financial self-service equipment according to the embodiments of the present application further has other effects of the sheet medium flattening device according to the embodiments, which will not be described herein.

The above embodiments in this specification are described in a progressive manner. Each of the embodiments is mainly focused on describing its differences from other embodiments, and references may be made among these embodiments with respect to the same or similar portions among these embodiments.

Based on the above description of the disclosed embodiments, those skilled in the art is capable of carrying out or using the present application. It is obvious for those skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A sheet medium flattening device, comprising:
a support frame, wherein a first passage plate and a second passage plate are arranged on the support frame, and a gap between the first passage plate and the second passage plate is a conveying passage; and
a conveying wheel set arranged in the conveying passage and configured to drive a sheet medium to be conveyed inside the conveying passage;
wherein, the first passage plate is provided with a through hole, and the second passage plate is provided with a groove at a position corresponding to the through hole; the sheet medium flattening device further comprises a flattening block, and the flattening block is configured to be controlled by a driving mechanism to extend into and withdraw from the conveying passage; and
wherein, in a case that the driving mechanism controls the flattening block to extend into the conveying passage, the flattening block is configured to push the sheet medium into the groove; and
in a case that the driving mechanism controls the flattening block to withdraw from the conveying passage, a next sheet medium is allowed to be conveyed along the conveying passage to a position corresponding to the groove.

2. The sheet medium flattening device according to claim 1, wherein the conveying wheel set comprises a first conveying wheel set, the first conveying wheel set comprises a driving wheel which is arranged on the first passage plate or the support frame and is rotatable around its own axis, and a driven wheel which is arranged on the second passage plate or the support frame and is rotatable around its own axis; the axis of the driving wheel is parallel with the axis of the driven wheel, the driving wheel and the driven wheel extend into the conveying passage, and wheel faces of the driving wheel and the driven wheel are abutting against each other; the driving wheel is driven by a first motor, and in a rotating process, the driving wheel is configured to drive the driven wheel to rotate reversely to convey the sheet medium clamped between the driving wheel and the driven wheel along the conveying passage.

3. The sheet medium flattening device according to claim 2, wherein the flattening block is located at a position upstream of the first conveying wheel set in a conveying direction of the sheet medium and close to the first conveying wheel set.

4. The sheet medium flattening device according to claim 3, further comprising a control unit, and a sensor located downstream of the first conveying wheel set in the conveying direction of the sheet medium, the sensor is arranged on the first passage plate and/or the second passage plate; the sensor is configured to detect whether the sheet medium is located in the conveying passage at a position corresponding to the sensor; and
in a case that a detection result of the sensor is YES, the control unit is configured to control the driving mechanism to move, to allow the flattening block to extend into the conveying passage to push the sheet medium tightly into the groove; and
in a case that the detection result of the sensor is NO, the control unit is configured to control the driving mechanism to move, to allow the flattening block to withdraw from the conveying passage.

5. The sheet medium flattening device according to claim 4, wherein a sliding slot is provided in the support frame at a position configured to assemble the flattening block, the driving mechanism comprises a second motor, an output shaft of the second motor is provided with a driving gear, the flattening block is provided with toothed grooves configured to mesh with the driving gear; and the second motor is configured to allow the flattening block to slide along the sliding slot through the driving gear, to extend into or withdraw from the conveying passage.

6. The sheet medium flattening device according to claim 4, wherein a value range of a distance d1 between an effective detecting point of the sensor and a first plane is: 0 mm<d1<15 mm; and the first plane is a plane where the axis of the driving wheel and the axis of the driven wheel lie.

7. The sheet medium flattening device according to claim 1, wherein an end surface of a top end, configured to cooperate with the groove, of the flattening block is an arc surface, and a range of a curvature radius R of the arc surface is 0 mm to 6 mm.

8. The sheet medium flattening device according to claim 7, wherein a value range of a distance d2 between a circle center of the arc surface and the first plane is: 5 mm<d2<15 mm; and the first plane is the plane where the axis of the driving wheel and the axis of the driven wheel lie.

9. The sheet medium flattening device according to claim 2, wherein the conveying wheel set further comprises a second conveying wheel set, the second conveying wheel set has the same structure with the first conveying wheel set, and the second conveying wheel set is located upstream of the first conveying wheel set in the conveying direction of the sheet medium; and a distance between the second conveying wheel set and the first conveying wheel set is smaller than a length of the sheet medium in the conveying direction.

10. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 1.

11. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 2.

12. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 3.

13. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 4.

14. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 5.

15. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 6.

16. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 7.

17. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 8.

18. A financial self-service equipment, wherein the financial self-service equipment has an outlet/inlet, and comprises a sheet medium storage device and a sheet medium conveying passage connecting the outlet/inlet with the sheet medium storage device; the sheet medium conveying passage is provided with the sheet medium flattening device according to claim 9.
